(19) United States
(12) Patent Application Publication
(10) Pub. No.: US 2020/0346416 A1
(43) Pub. Date: Nov. 5, 2020

(54) INTEGRATED STRUCTURE OF DIFFERENT KINDS OF MATERIALS AND METHOD OF INTEGRATING DIFFERENT KINDS OF MATERIALS

(71) Applicants: Hyundai Motor Company, Seoul (KR); Kia Motors Corporation, Seoul (KR)

(72) Inventor: Won Ki Song, Seongnam (KR)

(21) Appl. No.: 16/567,798

(22) Filed: Sep. 11, 2019

(30) Foreign Application Priority Data
May 2, 2019 (KR) 10-2019-0051688

(51) Int. Cl. B29C 65/00; B29C 65/20; B21D 22/02

(52) U.S. Cl. CPC B29C 66/74283; B29C 66/721; B32B 15/08; B21D 22/022; B29C 65/20

(57) ABSTRACT

Disclosed are an integrated structure of different kinds of materials formed by integrating a steel material and a fiber reinforced composite material, and a method of integrating different kinds materials. An integrated structure of different kinds of materials may be formed by integrating different kinds of materials that are a steel material and a fiber reinforced composite material. The integrated structure includes: a first plate including a steel material; and a second plate facing the first plate and including a fiber reinforced composite material, which may be formed by impregnating resin in a reinforced fiber. In particular, a thermal bonding layer may be formed at an interface of the first plate and the second plate and include the resin of the second plate which is thermally bonded on a surface of the first plate.

### CROSS-REFERENCE TO RELATED APPLICATION

This application claims priority to Korean Patent Application No. 10-2019-0051688, filed on May 2, 2019 in the Korean Intellectual Property Office, the disclosure of which is incorporated herein by reference.

### TECHNICAL FIELD

The present invention relates to an integrated structure including different kinds of materials and a method of producing an integrated structure including different kinds of materials. Particularly, an integrated structure of different kinds of materials may be formed by integrating a steel material and a fiber reinforced composite material through thermal bonding.

### BACKGROUND OF THE INVENTION

A vehicle body is manufactured by forming various kinds of plates. For example, as the plates for manufacturing car bodies, various materials including a steel plate such as ultra-high strength steel, a nonferrous metal plate such as aluminum or magnesium, and a fiber reinforced composite material such as Fiber Reinforced Plastic (FRP) are used.

The fiber reinforced composite material is excellent in strength, elastic modulus, light weight, and stability, so it has been spotlighted as one of important materials in the fields of aircrafts and vehicles. Further, the fiber reinforced composite material will be increasingly used and the manufacturing amount will be remarkably increased.

The fiber reinforced composite material is formed by impregnating a reinforced fiber such as a carbon fiber or a glass fiber with a resin and hardening the resin in the reinforced fiber, and for example, it may be manufactured by forming a carbon fiber or a glass fiber in a non-woven fabric form or a textile and then impregnating with plastic resin and hardening plastic resin.

Meanwhile, recently, as car bodies are increased in strength and decreased in weight, different kinds of materials have been used after bonding.

For example, the center pillars of vehicles have been made of steel materials in the related art, however, recently, a steel material and a fiber reinforce composite material have been combined and used to reduce the weight.

In order to combine a steel material and a fiber reinforce composite material, a method of separately forming first a steel plate made of a steel material and a composite material plate made of a fiber reinforced composite material as single products, and then combining these different kinds of plates has been used, for example, by hot stamping.

Meanwhile, in order to combine different kinds of plates, welding or coupling that uses fasteners has been applied. However, welding may not be suitably for different kinds of plates so it causes some defect, for example, the coupling force is small even if different kinds of materials are welded.

Further, according to coupling that uses fasteners, which is a method of fastening different kinds of plates using fasteners such as a rivet and a bolt, the number of processes is increased due to a need for pre-processing and post-processing for fastening, and fasteners are partially applied. Accordingly, the fastening force of different kinds of materials is not uniform.

The description provided above as a related art of the present invention is just for helping understanding the background of the present invention and should not be construed as being included in the related art known by those skilled in the art.

### SUMMARY OF THE INVENTION

In preferred aspects, provided, inter alia, are an integrated structure including different kinds of materials and a method of producing an integrated structure including different kinds of material. As such, the different kinds of materials, such as a steel material and a fiber reinforced composite material, may be uniformly integrated by thermally bonding. For example, a resin of the fiber reinforced composite material may be melted and thermally bonded to the steel material on the interface between the steel material and the fiber reinforced composite material.

In an aspect, provided is an integrated structure of different kinds of materials, which may be formed by integrating plates of different kinds of materials that are a steel material and a fiber reinforced composite material. The integrated structure may include: a first plate including a steel material; and a second plate including a fiber reinforced composite material. The fiber reinforced composite material may include a resin and a reinforced fiber. Preferably, the fiber reinforced composite material may be formed by impregnating the reinforced fiber with the resin.

Preferably, a thermal bonding layer may be formed at an interface of the first plate and the second plate, and may comprise the resin of the second plate. For instance, the resin of the second place may be thermally bonded on a surface of the first plate.

As referred to herein, a reinforced fiber may include a material in formed in fiber having directionally enforced strength (e.g., in the longitude direction). Exemplary reinforced fiber includes, for example, a glass (e.g., fiber glass), carbon (e.g., carbon fiber, carbon paper, carbon nanotubes, or carbon nanofibers), aramid, basalt, cellulose (e.g., paper or wood), or asbestos. Preferred reinforced fiber may suitably include a glass fiber.

A first curved portion having a first recessed groove shape and including a first floor region and first side regions may be formed at the first plate, a second curved portion having a second recessed groove shape corresponding to the first curved portion and having a second floor region and second side regions may be formed at the second plate. Preferably, the second curved portion may be disposed to overlap the inner side of the first curved portion.

At least one or more slit flanges protruding toward the second plate may be suitably formed on the first side regions of the first plate. At least one or more coupling holes through which the slit flanges are inserted may be suitably formed through the second side regions of the second plate at positions corresponding to positions of the slit flanges. Further, the slit flanges may be suitably inserted through the coupling holes and then end portions thereof may be suitably bent to come in close contact with a surface of the second plate.

The reinforced fiber of the second plate may suitably include a glass fiber.

In an aspect, provided is a method of producing an integrated structure by integrating different kinds of materials. The method may include: preparing a first plate comprising a steel material and a second plate comprising a fiber reinforced composite material including a reinforced fiber and a resin; stacking sequentially the first plate and the second plate in a cavity of the lower mold; heating the lower mold and the upper mold; forming the first plate and the second plate in a shape corresponding to the shape of the cavity by heating and pressing the first plate and the second plate stacked in the cavity of the lower mold using the heated upper mold; and cooling the heated and pressed first plate and second plate. The method of manufacturing an integrated structure by integrating plates of different kinds of materials that are a steel material and a fiber reinforced composite material using a hot stamping mold composed of a lower mold and an upper mold.

The reinforced fiber may suitably be impregnated with the resin in the fiber reinforced composite material.

In the fiber reinforced composite material, the resin of the second plate may be melted on a surface of the first plate at an interface between the first plate and the second plate, in the cooling the molten resin of the second plate may be hardened on the surface of the first plate. Preferably, a thermal bonding layer may be integrally formed at the interface between the first plate and the second plate by cooling the lower mold and the upper mold.

A curved portion having a recessed groove shape and including a floor region and side regions may be formed at the cavity of the lower mold. The method may further include temporarily forming the first plate in a shape corresponding to the curved portion after the preparing.

A curved portion having a recessed groove shape and including a floor region and side regions may be formed at the cavity of the lower mold. The upper mold may be divided into a center mold part for pressing the floor region and at least one or more side mold parts disposed at sides of the center mold part to press the side regions. Preferably, the first plate and the second plate are formed by steps including: a first forming process of forming a first floor region at the first plate to correspond to the floor region and forming a second floor region corresponding to the floor region at the second plate by pressing the first plate and the second plate with the center mold part; and a second forming process of forming first side regions at the first plate to correspond to the side regions and forming second side regions corresponding to the side regions at the second plate by laterally pressing the first plate and the second plate with the side mold parts.

A curved portion having a recessed groove shape and including a floor region and side regions may be formed at the cavity of the lower mold, a pressing surface of the upper mold may include a material having a thermal expansion coefficient greater than thermal expansion coefficients of the lower mold and other regions of the upper mold in the forming, the pressing surface of the upper mold may press the second plate by absorbing heat of the heated lower mold and expanding.

A curved portion having a recessed groove shape and including a floor region and side regions may be formed at the cavity of the lower mold. In the preparing the first plate and the second plate, preferably, a first curved portion having a recessed groove shape and including a first floor region and first side regions may be formed at the first plate. Preferably, a second curved portion having a second recessed groove shape and including a second floor region and second side regions may be formed at the second plate in a shape corresponding to the floor region and the side regions formed at the cavity of the lower mold. At least one or more slit flanges protruding toward the second plate may be formed on the first side regions of the first plate, and at least one or more coupling holes through which the slit flanges may be inserted are formed through the second side regions of the second plate at positions corresponding to positions of the slit flanges.

The first plate and the second plate may be stacked such that the slit flanges of the first plate may be inserted through the coupling holes of the second plate in the stacking step, and the end portions of the slit flanges may be bent by pressing with the upper mold to come in close contact with a surface of the second plate in the forming.

According to various exemplary embodiments of the present invention, a plate made of a steel material and a plate made of a fiber reinforced composite material may be formed into a resultant product shape by heating and pressing both of the plates in the hot stamping mold, in which resin of the fiber reinforced composite material may be thermally bonded to the steel material by the heat. Accordingly, different kinds of materials may be formed in an integrated structure or resultant product shape through one process. As such, number of processes when manufacturing a vehicle using different kinds of materials may be reduced. Further, uniform bonding force may be expected throughout the interface between the different kinds of materials.

Other aspect of the invention are disclosed infra.

### BRIEF DESCRIPTION OF THE DRAWINGS

The above and other aspects, features and advantages of the present invention will be more apparent from the following detailed description taken in conjunction with the accompanying drawings, in which:

FIG. 1 shows a cross-sectional view of an exemplary integrated structure of different kinds of materials according to an exemplary embodiment of the present invention;

FIG. 2 shows a cross-sectional view of an exemplary integrated structure of different kinds of materials according to an exemplary embodiment of the present invention;

FIG. 3 shows an exemplary process of manufacturing an exemplary integrated structure of different kinds of materials according to an exemplary embodiment of the present invention;

FIG. 4 shows an exemplary process of manufacturing an exemplary integrated structure of different kinds of materials according to an exemplary embodiment of the present invention;

FIG. 5 shows a cross-sectional of an exemplary integrated structure of different kinds of materials according to an exemplary embodiment of the present invention;

FIG. 6 shows a cross-sectional of an exemplary integrated structure of different kinds of materials according to an exemplary embodiment of the present invention;

FIG. 7 shows an exemplary process of manufacturing an exemplary integrated structure of different kinds of materials according to an exemplary embodiment of the present invention; and

FIG. 8 shows an exemplary process of manufacturing an exemplary integrated structure of different kinds of materials according to an exemplary embodiment of the present invention;

FIG. 9 shows an exemplary process of manufacturing an exemplary integrated structure of different kinds of materials according to an exemplary embodiment of the present invention.

### DETAILED DESCRIPTION

Hereinafter, embodiments of the present invention are described in detail with reference to the accompanying drawings. However, the present invention is not limited to the following embodiments and can be implemented in various ways different from one another, and the embodiments are provided to complete the present invention and to completely inform those skilled in art of the scope of the present invention. The same components are given the same reference number in the drawings.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, regions, integers, steps, operations, elements and/or components but do not preclude the presence or addition of one or more other features, regions, integers, steps, operations, elements, components, and/or combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g.

fuels derived from resources other than petroleum). As referred to herein, a hybrid vehicle is a vehicle that has two or more sources of power, for example both gasoline-powered and electric-powered vehicles.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. Hereinafter, a detailed description will be given of an exemplary radio wave penetration-type multilayer optical coating according to various exemplary embodiments of the present invention with reference to the appended drawings.

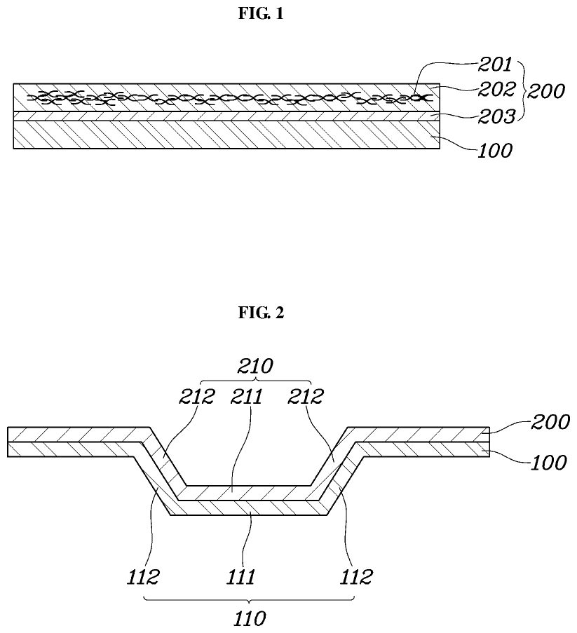

FIG. 1 shows a cross-sectional view of an exemplary integrated structure of different kinds of materials according to an exemplary embodiment of the present invention. In the integrated structure of different kinds of materials as shown in FIG. 1, a structure may be formed by integrating a steel material and a fiber reinforced composite material, a first plate 100 made of a steel material and a second plate 200 facing the first plate 100 and made of a fiber reinforced composite material formed by impregnating resin 202 in a reinforced fiber 201 may be combined in contact with each other.

A steel plate such as ultra-high strength steel or a nonferrous metal plate such as aluminum or magnesium may be applied to the steel material of the first plate 100.

A fiber reinforced composite material having a low specific weight and similar level of strength in comparison to the first plate 100 may be applied to the second plate 200.

Further, the second plate 200 may be formed by impregnating the resin 202 in the reinforced fiber 201. As the reinforced fiber 201 and the resin 202 forming the second plate 200, various kinds of reinforced fibers and resins that can form a fiber reinforced composite material may be selectively applied.

However, the fiber reinforce composite material that is used for the second plate 200 may have non-conductivity to prevent corrosion due to a potential difference from the first plate 100 made of a steel material. Accordingly, the reinforced fiber 201 and the resin 202 that are applied to the second plate 200 may have non-conductivity.

Accordingly, the reinforced fiber 201 that is applied to the second plate 200 may be a glass fiber and the resin 202 may be various kinds of non-conductive resins. All types of short fiber, long fiber, and continuous fiber may be used independently or in combination as the glass fiber.

Meanwhile, the present invention is characterized by bonding the first plate 100 and the second plate 200 through thermal bonding. For example, the thermal bonding may be formed by heating and pressing without using specific adhesives or fasteners.

Accordingly, a thermal bonding layer 203 may be formed at the interface of the first plate 100 and the second plate 200 by thermally bonding the resin 202 of the second plate 200 on a surface of the first plate 100.

Meanwhile, the first plate 100 and the second plate 200 may be formed in a shape corresponding to the products to be used, and may be modified in various ways according to the shapes of the products. For example, the integrated structure of different kinds of materials that is formed by bonding the first plate 100 and the second plate 200 to each other may be applied to a center pillar that is a part for the car body structure of a vehicle. Accordingly, center pillars of a steel material that are generally used in the related art may be replaced by the center pillar formed by the integrated structure of different kinds of materials.

The integrated structure of different kinds of materials that is formed by bonding the first plate 100 and the second plate 200 to each other may be formed not only in the shape of a flat product, but in various shapes, so various shapes of curved portions may be formed in the integrated structure of different kinds of materials.

FIG. 2 shows a cross-sectional view of an exemplary integrated structure of different kinds of materials according to an embodiment of the present invention, in which a curved portion may be formed in the integrated structure of different kinds of materials.

The first plate 100 and the second plate 200 constituting the integrated structure of different kinds of materials may be integrated by thermal bonding, and curved portions may be formed in corresponding shapes in the first plate 100 and the second plate 200.

In other words, a first curved portion 110 having a recessed groove shape and composed of a first floor region 111 and first side regions 112 is formed at the first plate 100 and a second curved portion 120 having a recessed groove shape corresponding to the first curved portion 110 and composed of a second floor region 121 and second side regions 122 is formed at the second plate 200. Accordingly, the second curved portion 120 may suitably be disposed to overlap the inner side of the first curved portion 110.

The first plate 100 and the second plate 200 may suitably be bonded by thermal bonding simultaneously with forming the first curved portion 110 and the second curved portion 120.

To this end, a hot stamping mold for forming steel material plates in the related art may be applied without limitation in the present invention.

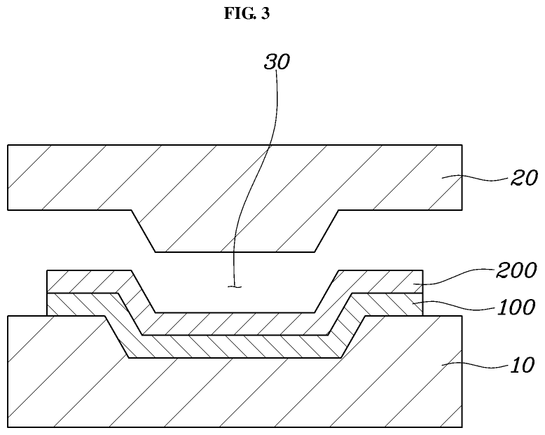

FIG. 3 shows an exemplary a process of manufacturing an integrated structure of different kinds of materials according to an exemplary embodiment of the present invention.

As shown in FIG. 3, an exemplary method of integrating different kinds of materials according to an exemplary embodiment of the present invention may be used to manufacture the integrated structure of different kinds of materials using a hot stamping mold composed of a lower mold 10 and an upper mold 20. A curved portion 31 having a recessed groove shape and composed of a floor region 31a and side regions 31b may be formed at the cavity 30 of the hot stamping mold, i.e. the cavity 30 of the lower mold 10.

First, the first plate 100 made of a steel material may be prepared and the second plate 200 made of a fiber reinforced composite material formed by impregnating resin 202 in the reinforced fiber 210 may be prepared (preparing step).

The first plate 100 and the second plate 200 may have flat plate shapes in this step.

The first plate 100 and the second plate 200 may be sequentially stacked on the cavity 30 of the lower mold 10 (stacking step).

After the first plate 100 and the second plate 200 are stacked, the lower mold 10 and the upper mold 20 may be heated (heating step).

In this step, the heating temperature for the lower mold 10 and the upper mold 20 may be controlled such that the resin 202 of the second plate 200 may be melted and thermally bonded to the interface with the first plate 100 made of a steel material. For example, the heating temperature for the lower mold 10 and the upper mold 20 may be about 200° C. at which the resin can be melted. Obviously, the heating temperature for the lower mold 10 and the upper mold 20 may be variously changed in accordance with the kind of the resin 202 that is applied to the second plate 200.

After the lower mold 10 and the upper mold 20 are heated to a desired level, the first plate 100 and the second plate 200 stacked on the cavity 30 of the lower mold 10 may be formed in the shape corresponding to the shape of the cavity 30 by heating the plates using the heated upper mold 20 (forming step).

When the first plate 100 and the second plate 200 are formed in the shape corresponding to the cavity 30 of the lower mold 10 and the upper mold 20, the resin 202 of the second plate 200 may be melted and thermally bonded to the interface with the first plate 100.

In particular, a first curved portion 110 and a second curved portion 120 may be formed respectively at the first plate 100 and the second plate 200 by the curved portion 31 formed at the cavity 30 of the hot stamping mold composed of the lower mold 10 and the upper mold 20.

Meanwhile, the heating step may be performed first and then the forming step may be performed, but the heating step and the forming step may be simultaneously performed.

After the first plate 100 and the second plate 200 are formed in desired shapes by the lower mold 10 and the upper mold 20 pressing the plates, the heated and pressed first plate 100 and second plate 200 may suitably be cooled (cooling step). Accordingly, a thermal bonding layer 203 may be formed at the interface between the first plate 100 and the second plate 200, whereby the first plate 100 and the second plate 200 may be integrated by thermal bonding.

In other words, as the lower mold 10 and the upper mold 20 are cooled in the cooling step, the molten resin of the second plate 200 may be hardened on the surface of the first plate 100, whereby the thermal bonding layer 203 may be integrally formed at the interface between the first plate 100 and the second plate 200.

Meanwhile, the bonding force may be insufficient between the first side regions 112 and the second side regions 122 because sufficient pressing force is not applied to the first side regions 112 and the second side regions 122 due to the shapes of the first curved portion 110 and the second curved portion 120 when the first plate 100 having the first curved portion 110 having a first recessed groove shape and composed of the first floor region 111 and the first side regions 112 and the second plate 200 having the second curved portion 120 having a shape corresponding to the first curved portion 110, having a second recessed groove shape, and composed of the second floor region 121 and the second side regions 122 may be thermally bonded using a hot stamping mold.

Accordingly, various complementary means may be applied to the present invention to prevent non-integration of the first plate 100 and the second plate 200 due to insufficient bonding force between the first side regions 112 and the second side regions 122.

First, the first plate 100 may be temporarily formed before the forming step to prevent non-integration between the first side regions 112 and the second side regions 122 due to insufficient forming of the first plate 100 made of a steel material when it is pressed by the upper mold 20.

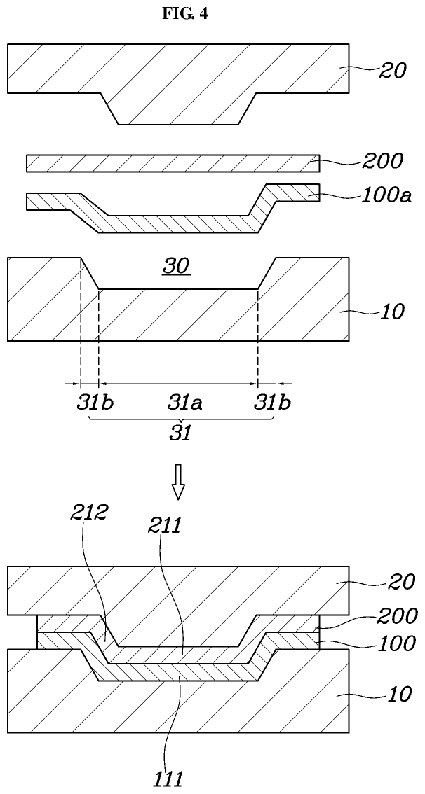

FIG. 4 shows an exemplary process of manufacturing an integrated structure of different kinds of materials according to another exemplary embodiment of the present invention.

As shown in the figure, the first plate 100 may be temporarily formed in the shape corresponding to the curved portion 31 formed at the cavity 30 of the lower mold 10 and the upper mold 20 after the preparing step (temporal forming step).

When the first plate 100 is temporarily formed, it may be possible to form first the first curved portion 110 at the first plate 100 in the shape accurately corresponding to the shape of the curved portion 31, but the first curved portion 110 may be formed to be less curved than the shape of the curved portion 31, that is, at a level between a plate shape and the shape of the curved portion 31.

After the first plate 100 is temporarily formed at a desired level before the forming step, it may suitably be pressed and formed in the finally desired shape in the forming step, thereby forming the first plate 100 in desired dimensions and integrating the first plate 100 and the second plate 200.

On the other hand, it may be possible to induce mechanical combination by changing the shapes of the first plate 100 and the second plate 200 as a complementary means for preventing non-integration of the first plate 100 and the second plate 200.

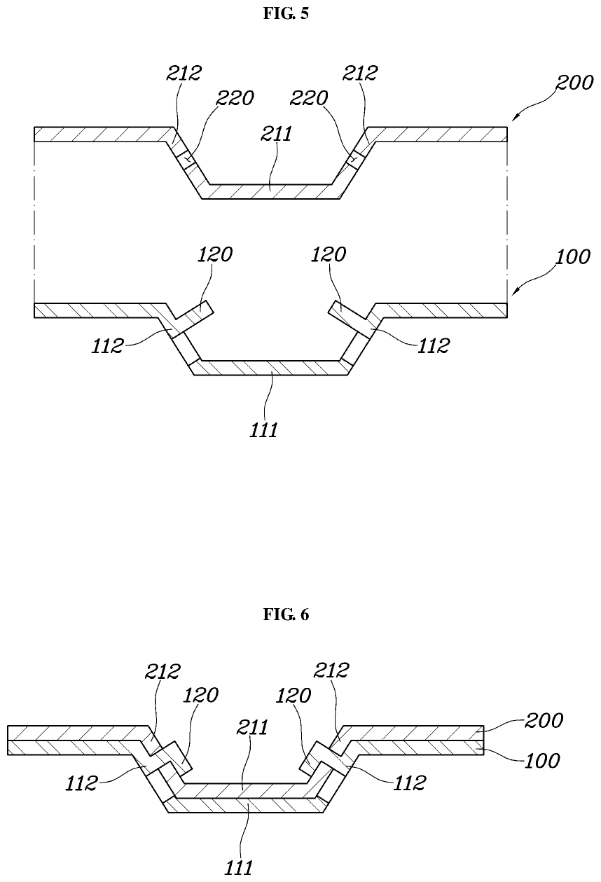

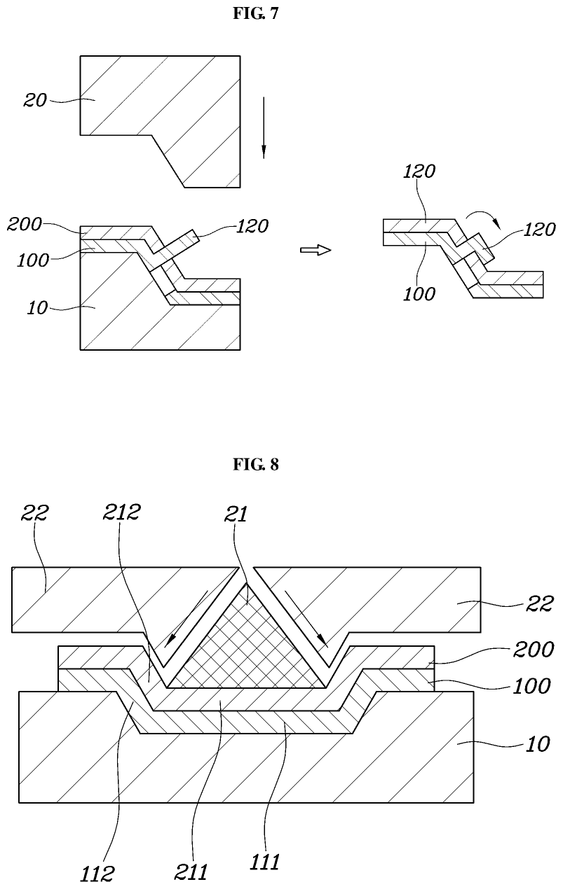

FIGS. 5 and 6 show cross-sectional views of an exemplary integrated structure of different kinds of materials according to another exemplary embodiment of the present invention and FIG. 7 shows an exemplary process of manufacturing an exemplary integrated structure of different kinds of materials according to another exemplary embodiment of the present invention.

In order to induce mechanical combination of the first plate 100 and the second plate 200, at least one or more slit flanges 120 protruding toward the second plate 200 may be formed on the first side regions 112 of the first plate 100 in the present invention.

Further, at least one or more coupling holes 220 through which the slit flanges 120 are inserted may be formed through the second side regions 122 of the second plate 200 at positions corresponding to the positions of the slit flanges 120.

Accordingly, when the first plate 100 and the second plate 200 are stacked, the slit flanges 120 may be inserted through the coupling holes 220 and then the ends thereof may be bent to come in close contact with the surface of the second plate 200.

By bending and bringing the slit flanges 120 formed on the first plate 100 onto the surface of the second plate, the first plate 100 and the second plate 200 may be mechanically combined without specific fasteners such as a rivet and a bolt. Obviously, the thermal bonding layer 203 may be integrally formed at the interface between the first plate 100 and the second plate 200 by thermal bonding, and combination made by bending the slit flanges 120 complements the integration by the thermal bonding layer 203.

To this end, in the preparing step, the first curved portion 110 having a recessed groove shape and composed of the first floor region 111 and the first side regions 112 may be formed at the first plate 100 and the second curved portion 120 having a recessed groove shape and composed of the second floor region 121 and the second side regions 122 may be formed at the second plate 200 in a shape corresponding to the floor region 31a and the side regions 3 lb formed at the curved portion 31.

Further, at least one or more slit flanges 120 protruding toward the second plate 200 may be formed at the first side regions 112 of the first plate 100 and at least one or more coupling holes 220 through which the slit flanges 120 are inserted may be formed at the second side regions 122 of the second plate 200 at the positions corresponding to the positions of the slit flanges 120.

Next, the first plate 100 and the second plate 200 may be stacked such that the slit flanges 120 of the first plate 100 may be inserted through the coupling holes 220 of the second plate 200 in the stacking step, and the end portions of the slit flanges 120 may be bent by pressing with the upper mold 20 to come in close contact with the surface of the second plate 200 in the forming step. In the forming step, thermal bonding of the first plate 100 and the second plate 200 may also be performed.

On the other hand, it may be possible to improve integration efficiency by changing the hot stamping mold composed of the lower mold 10 and the upper mold 20 as a complementary means for preventing non-integration of the first plate 100 and the second plate 200.

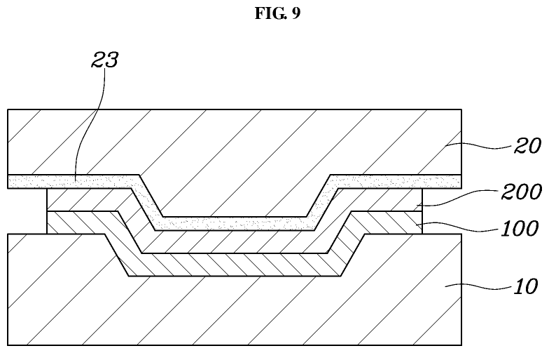

FIGS. 8 and 9 show an exemplary process of manufacturing an exemplary integrated structure of different kinds of materials according to an exemplary embodiment of the present invention in another way.

First, as shown in FIG. 8, an upper mold 20 may be divided into a center mold part 21 for pressing the floor region 31a and at least one or more side mold parts 22 may be disposed at sides of the center mold part 21 to press the side regions 31b.

In the forming step, a first floor region 111 may be formed at the first plate 100 to correspond to the floor region 31a and a second floor region 121 corresponding to the floor region 31a may be formed at the second plate 200 by pressing the first plate 100 and the second plate 200 with the center mold part 21 (first forming step). After the first floor region 111 and the second floor region 121 are formed first, and then first side regions 112 may be formed at the first plate 100 to correspond to the side regions 31b and second side regions 122 corresponding to the side regions 31b may be formed at the second plate 122 by laterally pressing the first plate 100 and the second plate 200 with the side mold parts 22 (second forming step).

By separately forming the first floor region 111 and the second floor region 121, and the first side regions 112 and second side regions 122, pressing force may be sufficiently applied to the first side regions 112 and second side regions 122, the first plate 100 and the second plate 200 may be formed in desired dimensions, and thermal bonding may be sufficiently generated on the interface.

Further, as shown in FIG. 9, the pressing force that presses the lower mold 10 may be increased by making a pressing surface 23 of the upper mold 20 using a material having a thermal expansion coefficient greater than the thermal expansion coefficients of the lower mold 10 and other regions of the upper mold 20 such that the pressing surface 23 of the upper mold 20 expands more than other regions in the forming step.

Accordingly, the pressing surface 23 of the upper mold 20 may apply sufficient pressing force to the first floor region 111, the second floor region 121, the first side regions 112, and the second side regions 122 by expanding and pressing the second plate 200 with larger pressure while absorbing the heat of the heated lower mold 10. As such, the first plate 100 and the second plate 200 may be formed in desired dimensions and thermal bonding to be sufficiently generated on the interface.

Although the present invention was described above with reference to the accompanying drawings and preferable embodiments, the present invention is not limited thereto, but is limited by the following claims. Accordingly, those skilled in the art may change and modify the present invention in various ways without departing from the spirit of the claims.

What is claimed is:

1. An integrated structure, comprising:
a first plate comprising a steel material; and
a second plate comprising a fiber reinforced composite material wherein the fiber reinforced composite material comprises a resin and a reinforced fiber;
wherein a thermal bonding layer is formed at an interface of the first plate and the second plate and comprises the resin of the second plate thermally bonded on a surface of the first plate.

2. The integrated structure of claim 1, wherein the reinforced fiber is impregnated with the resin.

3. The integrated structure of claim 1, wherein a first curved portion having a first recessed groove shape and comprising a first floor region and first side regions is formed at the first plate, a second curved portion having a second recessed groove shape corresponding to the first curved portion and comprising a second floor region and second side regions is formed at the second plate, and the second curved portion is disposed to overlap the inner side of the first curved portion.

4. The integrated structure of claim 3, wherein at least one or more slit flanges protruding toward the second plate are formed on the first side regions of the first plate,
at least one or more coupling holes through which the slit flanges are inserted are formed through the second side regions of the second plate at positions corresponding to positions of the slit flanges, and
the slit flanges are inserted through the coupling holes and then end portions thereof are bent to come in close contact with a surface of the second plate.

5. The integrated material of claim 1, wherein the reinforced fiber comprises a glass fiber.

6. A method of producing an integrated structure using a hot stamping mold composed of a lower mold and an upper mold, comprising:
preparing a first plate comprising a steel material and a second plate comprising a fiber reinforced composite material wherein the fiber reinforced composite material comprises a reinforced fiber and a resin;
stacking sequentially the first plate and the second plate in a cavity of the lower mold;
heating the lower mold and the upper mold;
forming the first plate and the second plate in a shape corresponding to the shape of the cavity the lower mold by heating and pressing the first plate and the second plate stacked in the cavity of the lower mold using the heated upper mold; and
cooling the heated and pressed first plate and second plate.

7. The method of claim 6, wherein the reinforced fiber is impregnated with the resin.

8. The method of claim 6, wherein, in the forming the first plate and the second plate, the resin of the second plate is melted on a surface of the first plate at an interface between the first plate and the second plate, and
in the cooling, the molten resin of the second plate is hardened on the surface of the first plate, whereby a thermal bonding layer is integrally formed at the interface between the first plate and the second plate by cooling the lower mold and the upper mold.

9. The method of claim 6, wherein a curved portion having a recessed groove shape and comprising a floor region and side regions is formed at the cavity of the lower mold.

10. The method of claim 9, further comprising temporarily forming the first plate in a shape corresponding to the curved portion after the preparing.

11. The method of claim 6, wherein a curved portion having a recessed groove shape and comprising a floor region and side regions is formed at the cavity of the lower mold,
the upper mold is divided into a center mold part for pressing the floor region and at least one or more side mold parts disposed at sides of the center mold part to press the side regions.

12. The method of claim 11, wherein the first plate and the second plate are formed by steps comprising:
a first forming process of forming a first floor region at the first plate to correspond to the floor region and forming a second floor region corresponding to the floor region at the second plate by pressing the first plate and the second plate with the center mold part; and
a second forming process of forming first side regions at the first plate to correspond to the side regions and forming second side regions corresponding to the side regions at the second plate by laterally pressing the first plate and the second plate with the side mold parts.

13. The method of claim 6, wherein a curved portion having a recessed groove shape and comprising a floor region and side regions is formed at the cavity of the lower mold,
a pressing surface of the upper mold comprises a material having a thermal expansion coefficient greater than thermal expansion coefficients of the lower mold and other regions of the upper mold, and
the pressing surface of the upper mold presses the second plate by absorbing heat of the heated lower mold and expanding in the forming.

14. The method of claim 6, wherein a curved portion having a recessed groove shape and comprising a floor region and side regions is formed at the cavity of the lower mold; and,
in the preparing the first plate and the second plate,
a first curved portion having a first recessed groove shape and comprising a first floor region and first side regions is formed at the first plate and a second curved portion having a second recessed groove shape and comprising a second floor region and second side regions is formed at the second plate in a shape corresponding to the floor region and the side regions formed at the cavity of the lower mold,
at least one or more slit flanges protruding toward the second plate are formed on the first side regions of the first plate, and
at least one or more coupling holes through which the slit flanges are inserted are formed through the second side regions of the second plate at positions corresponding to positions of the slit flanges.

15. The method of claim 14, wherein the first plate and the second plate are stacked such that the slit flanges of the first plate are inserted through the coupling holes of the second plate in the stacking step, and
the end portions of the slit flanges are bent by pressing with the upper mold to come in close contact with a surface of the second plate in the forming.

16. A vehicle comprising an integrated material of claim 1.
